(19) United States
(12) Patent Application Publication
(10) Pub. No.: US 2004/0166467 A1
(43) Pub. Date: Aug. 26, 2004

(54) Dental marking film holder

(76) Inventor: Nathaniel David Crow, Cocolalla Lake, ID (US)

Correspondence Address: KEITH S BERGMAN, ATTORNEY AT LAW, 7 SOUTH HOWARD STREET, SUITE 418, SPOKANE, WA, 992013898

(21) Appl. No.: 10/374,301

(22) Filed: Feb. 25, 2003

(51) Int. Cl. A61C 3/04; A61C 9/00

(52) U.S. Cl. 433/49; 433/70

(57) ABSTRACT

Apparatus supported on the brow beam of protective eye glasses worn by a dental patient provides a moveably positionable holder arm depending spacedly forward of a user's nose and spacedly below the user's mouth. The holder arm carries marking film holding structure for vertically adjustable frictional motion thereon. The marking film holding structure provides two pivotally interconnected holder arms extending toward the patient's mouth for adjustable frictional motion in a horizontal plane through the patient's mouth and substantially perpendicular to the holder arm. The holder arms releasably carry dental marking film structures having dental marking film supported by a rigid back releasably carried by the holder arms to allow marking of contact points of teeth of the opposed dental arches upon appropriate manipulation.

### BACKGROUND OF INVENTION

### RELATED APPLICATIONS

There are no applications related hereto heretofore filed in this or any foreign country.

1. Field of Invention

My invention relates generally to dental apparatus and more particularly to apparatus that is supported on patient safety eye glasses to depend therefrom and carry dental marking film for adjustable extension into a patient's oral cavity and positional maintenance therein for use.

2. Background and Description of Prior Art

In the practice of dentistry it is often necessary to determine the occlusional contact of the teeth of the upper and lower dental arches for diagnosis or treatment. This determination is made by imprinting in present day dentistry and is commonly made by use of articulating film comprising a thin flexible base material carrying transferrable dye on one or both sides. Such articulating film commonly is commercially provided in the form of small rectilineal strips having peripheral dimensions of approximately 0.75×2.50 inches and, when formed of metal foil or mylar plastic, having a thickness ranging from about 0.003 to 0.0008 inch (7.62 to 2.032 microns). This articulating film commonly has been supported in a patient's mouth between the dental arches by reusable, long nosed forceps commonly known as “Miller forceps” and in more recent times by single use disposable forceps or supports that are rigid interconnected elongate holding elements such as that described in U.S. Pat. No. 5,181,849 issued to Callne.

The use of either Miller forceps or non-metallic single use support generally has required two people to accomplish the marking process. A first person, usually a dental assistant, positionally maintains articulating film in proper position in a patient's mouth and a second person, usually a dentist, moves the patient's mandible to cause marking on the immediately adjacent surfaces of the opposed dental arches at contact points.

This procedure has various drawbacks which the instant invention seeks to remedy or do away with by providing an apparatus carried by the bridge beam of commercially available patient safety glasses to depend forwardly of a patient's face to moveably and adjustably support and positionally maintain one or more single use dental marking films between the patient's dental arches to allow occlusional contact marking by only one person, without the aid of an assistant.

The instant holder, in doing away with need for a dental assistant, provides more working space around the patient's mouth and makes that working space more convenient of use by the dentist. With my holder only two hands rather than four are in the space about the patient's head and mouth.

During times of unexpected short staffing in dental offices as a result of a vacation, sickness or the like, skilled and trained assistants might not be available to hold articulating films and the treatment efficiency of the dentist may decrease as he or she may have to stop treatment to find help to hold marking films.

The manual placement of articulating film by dental assistants is technique sensitive and requires training and practice to correctly and precisely position and positionally maintain the films between all relevant teeth while the patient's jaw is being manipulated. This manual holding and positioning of articulating film is an under utilization of highly trained and skilled assistants and the patient in such procedure is often intimidated and cannot relax with the obtrusion of four hands into the space about his or her face and mouth while the obtrusion of only two hands, and especially those of the dentist, is less disruptive of the patient's psyche.

Miller forceps are still widely used in present day dental practice and present additional problems over the instant holder. Such forceps usually are made of stainless steel and require sterilization between uses. Loading these forceps with articulating film often requires touching the film in positioning it between the opposed grasping jaws of the forceps. This touching tends to transfer marking dye on the films to the user's fingers or gloves or to the film grasping forceps. The jaws of reusable forceps are difficult to clean by reason of oil and dye which stick between the marking film and adjacent forcep surfaces, which commonly are serrated or cross-hatched to aid grasping the smooth, relatively thin marking film.

In prior marking processes using an assistant, the assistant's hands necessarily must be spacedly adjacent to the patient's mouth to accomplish their purpose. This hand positioning tends to block the view of marking film placement within the patient's mouth, not only to make the film placement difficult but also to prevent confirmation of proper film placement so that the film may not cover all teeth desired to be covered and marks may be inadvertently missed with resulting diagnoses being incorrectly made. Additionally, without visualization in the placement or positional maintenance of marking films, the films may become folded, wetted or wrinkled which can result in failed marking or erroneous marks. Without visualization of the patient's cheeks and gums they may be poked and the patient may bite on the metal jaws of a Miller forcep. Metal forceps also have high heat conductivity and often are at a temperature different from that of a patient's mouth tissue, so that if they come into contact with the mouth tissue, or sometimes even the teeth, this may cause patient discomfort.

With either multi-use metallic forceps or single use non-metallic forceps, in the existing practice using dental assistants to hold the forceps total support comes from the dental assistant, without necessary reference to patient position. This type of support is difficult to maintain and tiring for the dental assistant. If the patient's head moves during the marking process the forceps holder must move responsively to maintain the marking film position that existed prior to the patient's motion. The instant apparatus solves these problems by reason of its support on the patient by safety glasses worn by the patient, so that patient head position will not affect the positional relationship of the marking film relative to the patient's dental arch.

The instant apparatus is particularly well adapted to use in the modern dental practice of relating contacting surfaces of the teeth of the upper and lower dental arches to the normal relaxed position of the temporal-mandibular joints (TM joints). The TM joints are formed by ball elements (condyli) at each end of the arched jaw bone (mandible) which articulate with two open socket elements defined in the under surface of the temporal bone in the skull, just in front of the tympanic bone of the ear structure. The TM joint sockets open inferiorly to permit downward and forward movements of the condyli, but are braced in the vertically upward direction by the concave shape of the temporal bone at the superior aspects of the joints. The TM joints during normal function pivot about an axis extending therebetween and may move forwardly and downwardly away from the axis of pivot. During pivotal movements both TM joint sockets brace both balls (condyli)of the lower jaw against the forces of vertical jaw closing muscles. Simultaneous contact of the upper and lower dental arches on the arc of closure insures stable contacting and holding surfaces which minimizes levered and torqueing forces on the TM joints created by uneven closure. Small interferences with the simultaneous contact of the dental arches as well as siding movements of the dental arches may cause closing forces in the bone braces of the TM joints and require additional muscle activity in order to brace the ball elements condyli of the jaw bone in place. These joint bracing muscles may tire while resisting the closing muscles and this may result in excessive forces beyond the ability of the muscles and joints to accommodate which can result in muscle pain and spasm, TM joint pathology and sometimes even loss of TM joint function.

Transitory or sliding jaw movements require muscle forces which move the balls (condyli) of the jaw forwardly and downwardly. Molars that contact during transitory movements cause closing muscles to contract to oppose the forward muscle forces. The result may cause muscle spasms of the opposing muscles and excessive forces on the TM joints which can cause structural failure, pain and loss of tooth structure through wear.

For maximum muscle efficiency, minimum opposition and the general health of the gnathic system, all closing forces after tooth contact should pass through the boney brace of the TM joints. All other chewing and jaw movements should be accomplished without molar teeth contact. Teeth can be marked for analysis and a treatment plan devised to change the relationship of tooth biting surfaces during function, to minimize muscle opposition, by use of dental articulating film which when touched, tapped or moved in relation to the adjacent teeth surfaces creates transferred dye marks.

In order to relate the arc of closure of the jaw to the first contact of the teeth, a dentist manually rotates the jaw while maintaining the anatomical center of rotation at the bone brace of both TM joints. At the same time marking film must be positioned and held in place between teeth of both dental arches for recording the initial contact of one or both sides of the dental arch. The jaw then is manually closed and lightly tapped to transfer dye to the teeth. The patient may then clinch his teeth to mark the surfaces which are in contact during moving of the teeth into full closure. The patient then can be asked to preform side-to-side and front-to-back chewing motions to mark tooth surfaces which are in contact during these movements. Minimal muscle opposition is achieved after all chewing and clenching movements mark the teeth with only dots on stable surfaces in the arc of closure of bicuspids and molars and translatory chewing motions mark the teeth with lines on the contacting surfaces of bicuspid and incisor teeth. My apparatus is particularly useful with this process.

Dental facebows of various sorts have long been known and used in the practice of dentistry especially for locating the contact axis of the lower jaw with respect to position of a patient's teeth. Measurements derived from facebows are used to transfer the general characteristics of a patient's gnathic system to an articulator to aid in the creation or proper configuration and fitting of dental prostheses. Such devices in general are measuring structures such as shown by Fitzsimmons, U.S. Pat. No 2,794,253; Levey, et al., U.S. Pat. No 3,069,774; Heydenreich, U.S. Pat. No 3,336,670; Balasz, U.S. Pat. No 3,382,581; Baum, U.S. Pat. No 3,555,684 and Stade, U.S. Pat. No 4,096,637. These devices generally do not provide firm or positionally sustainable or re-establishable support on a patient's head structure and are not concerned with the support and positional maintenance of marking film for determining the interfacial contact of the maxillary and mandibular dental arches.

Dental facebows having more permanent and positionally re-establishable support on the head of a patient are shown by Wilkinson, U.S. Pat. No 3,024,534, which supports the dental aligner by lateral ear bows and a medial nose bridge plate and by Behrend, U.S. Pat. No 4,634,377 which provides lateral ear bows with earplugs supported in the patient's auditory canals and a medial rim supported on the patient's nose bridge. Both of these latter references again are measuring devices and neither is concerned with the support of dental marking film.

The reference of Callne, U.S. Pat. No 5,181,849 shows a single use plastic forceps for holding dental marking film, but does not show any type of facebow-like apparatus supported on a patient for holding or positionally maintaining the supported marking film in a patient's mouth between the dental arches.

### SUMMARY OF INVENTION

The instant marking film holder is supported on dental patient safety glasses having lateral over-the-ear bows interconnected by a face bow with a medial nose bridge for support on the patient's nose. The marking film holder provides a body fastenable to the nose bridge of supporting safety glasses and moveably carrying an elongate depending holder arm. A first species of holder arm is of a compound nature providing rigid upper and lower portions joined by a medial frictionally adjustable joint to allow the lower portion to pivot toward and away from a patient's mouth relative to the upper portion. A second species of holder arm is of a simple nature providing a continuous L-shaped rod or a rod formed of somewhat resilient and manually formable material such as softer plastic or metal to allow limited adjustment and passage of the lower portion of the holder arm forwardly of a patient's nose. A marking film holder having two frictionally adjustable pivotally mounted holding arms extending toward the patient's mouth is carried on the lower portion of the holder arm for frictionally restrained adjustable slidable motion thereon. Each of the holding arms define a medial channel to releasably carry and positionally maintain a manipulating handle portion of a marking film structure. The marking film structures provide opposed rigid jaws with a and carrying a strip of dental marking film therebetween to extend spacedly from one side thereof for teeth marking and have a fastening handle extending longitudinally therefrom.

In providing such apparatus it is;

A principal object to provide a holder for dental marking film that is releasably supported by the nose bridge of the facial bow of a pair of safety glasses worn by a dental patient.

A further object is to provide such a holder that positionally maintains one or more dental marking films in marking position in the mouth of a patient between the dental arches without the assistance of a person after placement.

A further object is to provide such a holder that allows better visualization of the mouth enclosure of a dental patient then would be had with two pairs of hands working about the mouth to manipulate marking tissue and a patient's lower jaw to mark occlusional contacts, while yet maintaining accurate marking film position without film distortion.

A still further object is to provide such a holder that releasably supports single use marking film structures having a rigid back carrying the marking film and a protruding fastening handle to do away with use of traditional reusable marking film holders.

A still further object is to provide such a holder that removes patient anxiety resulting from the presence of four hands immediately adjacent the oral orifice when using marking film with traditional methods.

A still further object is to provide such a holder that allows a better and more clear working area about the patient's mouth, allows better visualization of the oral cavity and allows simultaneous manipulation of the mandibular bone and determination of TM joint position by one person as an incident to marking contact points of the upper and lower dental arches.

A still further object is to provide such a holder that is of new and novel design, of rugged and durable nature, of simple and economic manufacture and is otherwise well suited to the uses and purposes for which it is intended.

Other and further objects of my invention will appear from the following specification and accompanying drawings which form a part hereof. In carrying out the objects of my invention, however, it is to be understood that its features are susceptible to change in design and structural arrangement with only the preferred embodiments being illustrated and specified as required.

### BRIEF DESCRIPTION OF DRAWINGS

In the accompanying drawings which form a part hereof and wherein like numbers of reference refer to similar parts throughout:

FIG. 1 is an isometric view of a first species of marking film holder apparatus, having a compound holder arm, in operative position on safety glasses worn by a dental patient.

FIG. 2 is an enlarged isometric view of the marking film holder of FIG. 1.

FIG. 3 is an enlarged partial vertical elongate cross-sectional view through the interconnection of the glasses fastening body and the holder arm, taken on the line 3-3 on FIG. 2 in the direction indicated by the arrows thereon.

FIG. 4 is an enlarged vertical lateral extending cross-sectional view through the glasses fastening body of the holder, taken on the line 4-4 on FIG. 2 in the direction indicated by the arrows thereon.

FIG. 5 is an enlarged vertical lateral extending cross-sectional view through the joint interconnecting the upper and lower portions of the holder arm, taken on the plane 5-5 on FIG. 2 in the direction indicated by the arrows thereon.

FIG. 6 is an enlarged vertical laterally extending cross-sectional view through the interconnection of the holder arm and marking film holder, taken on the plane 6-6 on FIG. 2 in the direction indicated by the arrows thereon.

FIG. 7 is an enlarged partial rear orthographic view of the marking film holder with the marking film structures for clarity of illustration.

FIG. 8 is an isometric view of protective eye glasses usable to support my marking film holder.

FIG. 9 is an isometric top view of a marking film structure usable with my marking film holder.

FIG. 10 is a vertical elongate cross-sectional view through the marking film structure of FIG. 9, taken on the line 10-10 thereon in the direction indicated by the arrows.

FIG. 11 is a vertical traverse cross-sectional view through the marking film structure of FIG. 9, taken on the line 11-11 thereon in the direction indicated by the arrows.

FIG. 12 is an isometric view of a second species of marking film holder, having a unitary L-shaped holder arm, in operative position on a dental patient.

FIG. 13 is an enlarged isometric view of the marking film holder of FIG. 12.

FIG. 14 is a partial enlarged vertical elongate cross-sectional view through the fastening body of the marking film holder of FIG. 13, taken on the line 14-14 thereon in the direction indicated by the arrows.

FIG. 15 is an isometric view of a first sub-species of the second species of marking film holder having a unitary holder arm of manually reformable nature and arcuate configuration.

FIG. 16 is a partial enlarged vertical elongate cross-sectional view through the fastening body of the marking film holder of FIG. 15, taken on the line 16-16 thereon in the direction indicated by the arrows.

FIG. 17 is a cross-sectional view of the second sub-species of marking film holder arm, having a unitary holder arm carried by a glasses fastening body having a downwardly and forwardly extending mounting arm, taken as on a line such as the line 16-16 on FIG. 15.

### DESCRIPTION OF PREFERRED EMBODIMENT

My marking film holder generally provides glasses fastening body 20 releasably fastenable to safety glasses 19 and carrying depending holder arm 21 which in turn carries marking film holder 22 which supports marking film structures 23.

Safety glasses 19, although not a part of my invention per se, are necessary for the invention's operability. These safety glasses 19 are of a commercially available type used for dental patient eye protection that have laterally opposed rearwardly extending ear bows 24 for support on the patient's ears. The ear bows 24 are interconnected in their forwardmost portions by face bow 25 having medial nose bridge support 26 and carrying depending protective lens 27 on each side of the nose bridge support 26. The only requirement for such safety glasses is that they provide this essential structure, with a nose bridge support 26 that allows releasable attachment of the glasses fastening body 20 of my holder thereto for positional maintenance.

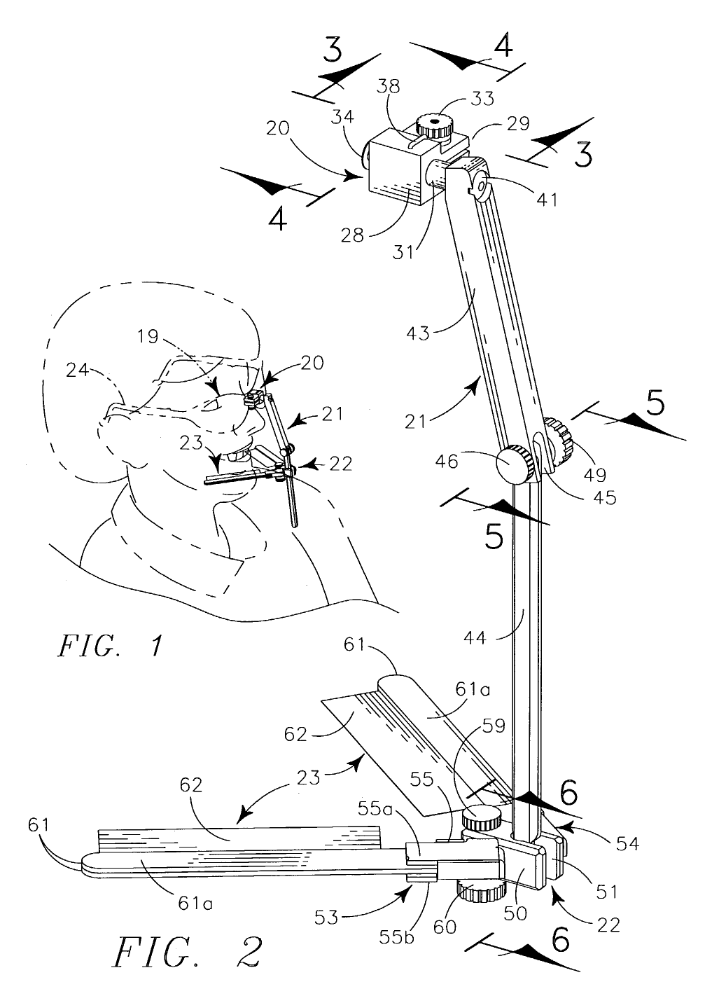

The first species of glasses fastening body 20 as seen in FIGS. 1-7, and especially in FIGS. 3 and 4, is somewhat of a U-shaped clamp comprising back 28 and laterally projecting spaced legs 29 which form the clamp structure. Back 28 defines hole 30 communicating elongately therethrough to releasably and movably carry holding arm fastening pin 31. Bolt 32 extends through holes 33 defined perpendicularly in axial alignment through legs 29 to threadly engage knurled nut 32a to move legs 29 relative to each other to regulate the amount of frictional contact of holding arm fastening pin 31 in hole 30. Bolt 34 passes through hole 35 defined in nose bridge support 26 of the safety glasses 19 to be fastenably engaged in threaded hole 36 defined in the rearward portion of glasses fastening body 20. Holding arm fastening pin 31 is held in hole 30 for rotatable motion by the legs of staple 38 extending through back 28 and into annular groove 39 defined in fastening pin 31, as seen in FIGS. 2 and 3. The forward portion of holding arm fastening pin 31 defines threaded hole 40 to threadedly receive bolt 41 extending through hole 42 in the upper portion of holder arm 21 to fasten the holder arm to glasses fastening body 20.

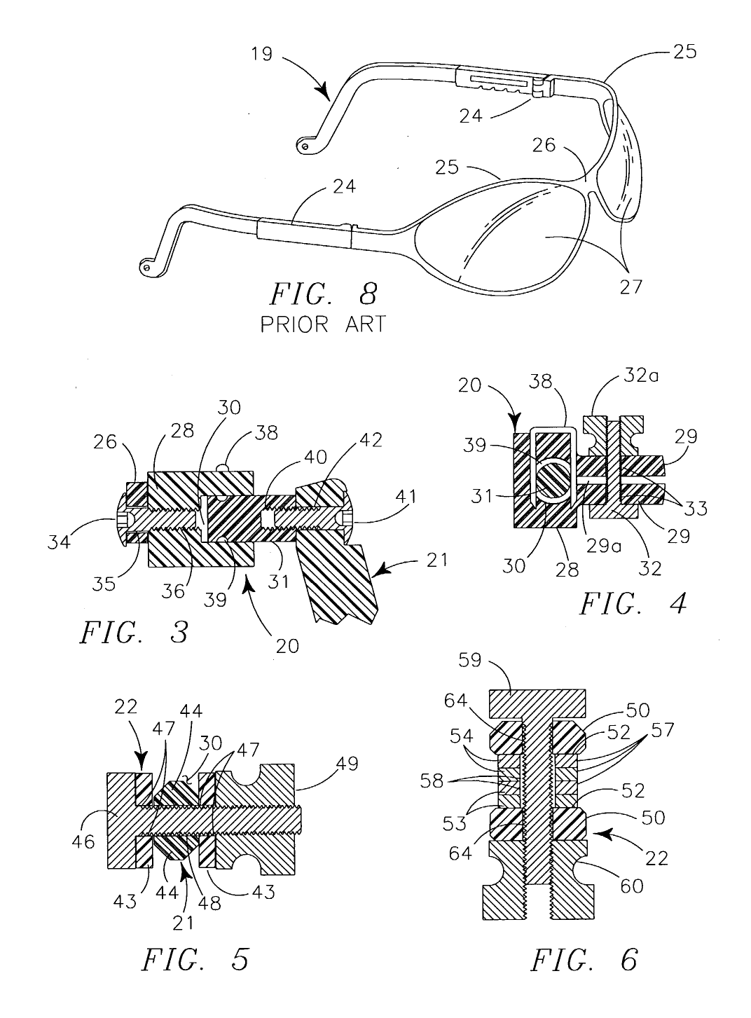

As seen particularly in FIGS. 2 and 5, holder arm 21 is a elongate compound structure, depending from rotatable support on glasses fastening body 20, comprising upper body portion 43 articulatingly interconnected with lower portion 44 to pivot in a vertical plane perpendicular to the vertical plane of rotation of upper body portion 43. The lower end of upper body portion 43 defines elogate slot 45 extending elongately therethrough to pivotably receive the upper connecting part of lower body portion 44. Bolt 46 extends through axially aligned holes 47 defined in the lower end of upper portion 43 and axially aligned hole 48 defined in the upper connecting part of lower body portion 44 to carry knurled nut 49 in threaded engaged on the opposite side of upper portion 43 to provide a frictionally adjustable pivotal joint between upper and lower portions 43,44 of compound holder arm 21.

Marking film holder 22 as seen in FIGS. 2, 6 and 7 provides rectilinear body 50 defining vertical slot 51 extending through its forward portion and horizontal slot 52 extending through its rearward portion. The forward vertical slot 51 is so configured as to receive lower portion 44 of holder arm 21 in a frictionally slidable fit so that the body 50 will be positionally maintained at a position once established on the lower holder arm portion 44, but will be manually moveable therefrom.

Rearward horizontal slot 52, in the instance illustrated in FIGS. 6 and 7, carries two marking film mounting arms 53 and 54. Each mounting arm 53,54 defines a medial rectilinear holding element 55 which in turn defines rectilinear channel 56 therein to slidably receive and frictionally positionally maintain the holding portion of a marking film structure 23. The upper portions 55a and lower portions 55b of holding elements 55 extend spacedly rearwardly from the rearward mouth of channel 56 to aid positioning of the of the holding portions marking film structures in channel 56. Forward portions of each holding element 55 define perpendicularly extending fastening portions 57 that are carried in rear horizontal slot 52. The paired fastening portions 57 of each mounting arm 53,54 are offset vertically relative to each other, as shown in FIG. 7, to maintain the channels 56 of both holding elements 55 in substantially the same horizontal plane to aid simultaneous tooth marking on both lateral aspects of the dental arches.

Each fastening portion 57 defines vertically orientated axially aligned holes 58 to receive bolt 59 for frictionally adjustable positional maintenance of the fastening portions 57 within slot 52 of body 50. Bolt 59 extends through axially aligned holes 64 defined through body 50 in a position axially coextensive with holes 58 in fastening portions 57 and threadedly engages knurled adjustment nut 60 on the opposite side of the body so that the nut 60 may be adjusted on the bolt 59 to adjust the frictional force resisting pivotal motion of the two holding elements 55 relative to each other and to body 50 for adjustable positional maintenance.

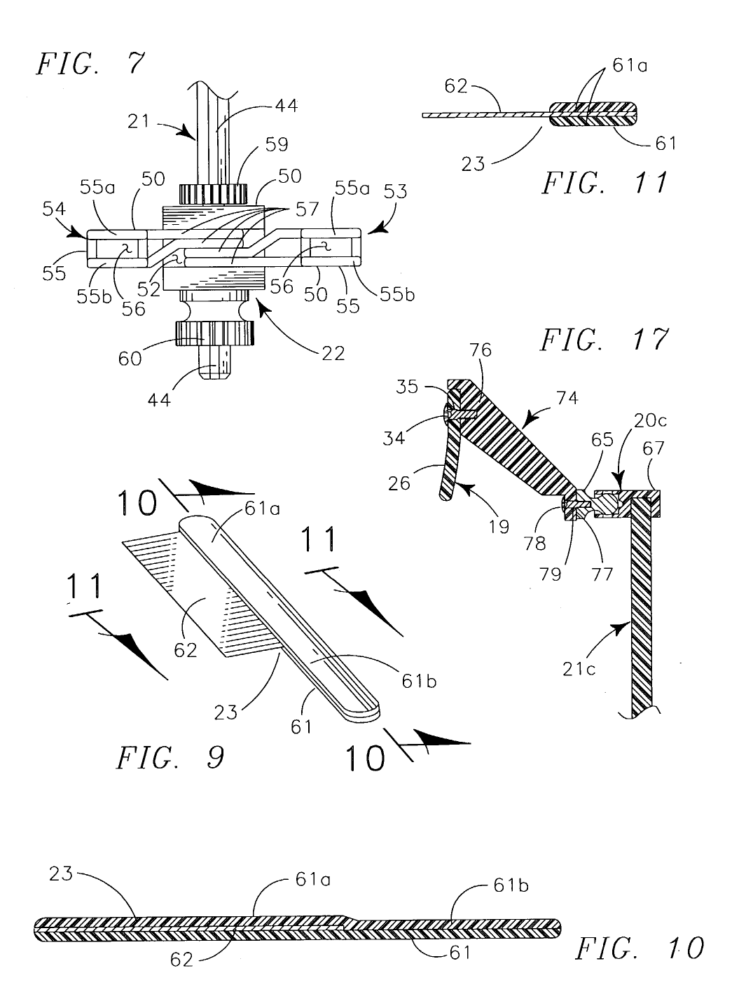

Marking film structure 23, as seen especially in FIGS. 9-11, provide a rigid forceps-like back 61 having film holding portion 61a and handle fastening portion 61b. The back 61 preferably is formed of two similarly configured pieces of rigid or semi-rigid polymeric or paper material with a strip of dental marking film 62 sandwiched therebetween in the film holding portion 61a to extend laterally therefrom. The marking film structure 23 generally, but not necessarily, is designed for single use applications, and if so, dental marking film 62 is joined to the adjacent portions of back 61 by some permanent joinder process. Commonly the portions of one or both sides of back 61, adjacent to the marking film, are formed with protuberances that extend through the marking film and into indentations or holes in the opposite back portion or the opposed sides of the back are joined by thermal welding processes or adhesion, all as known in the prior art for forming similar marking film structures.

The handle fastening portion 61b of back 61 is configured to fit within channel 56 of holding element 55 in a frictional fit that is positionally sustaining but yet allows manual manipulation for insertion and removal. If such fit may not be obtained by dimensioning the handle portion 61b it may be aided by forming one or more protuberances (not shown) on one or more surfaces of handle fastening portion 61b or the adjacent inner surfaces of holding element 55 defining channel 56.

Marking film 62 may be of the ordinary type commercially available in the present day marketplace. This marking film generally comprises a relatively thin flexible film of polymeric material, or possibly metalic foil, normally ranging in thicknesses from about 5 to 20 microns (0.0002 to 0.0008 inch) for proper marking. The marking film is of substantially rectilinear configuration with a length parallel to the longer dimension of back 61 of approximately 2.75 inches and a width perpendicular to the length of approximately 0.75 inch. One or both sides of the marking film are coated with transferrable dye material that may be imprinted on tooth surfaces coming in contact therewith, especially when such contact has some slight impact or pressure. Commonly if two sided marking films used the colored marking dyes on each surface are different in color from each other to avoid confusion in analyzing marks on a patient's teeth.

The holder may be formed of most rigid material but the structure of preference is formed of both metallic and plastic elements for ease of manufacture and subsequent durability. Preferably all nuts and bolts are formed of metal as are staple 38, holding arm fastening pin 31 and marking film holders 22. The glasses fastening body 20, upper portion 43 and lower portion 44 of holder arm 21 are preferably formed of polymeric material as are body 50 of the marking film holder and back 61 of the marking film structures.

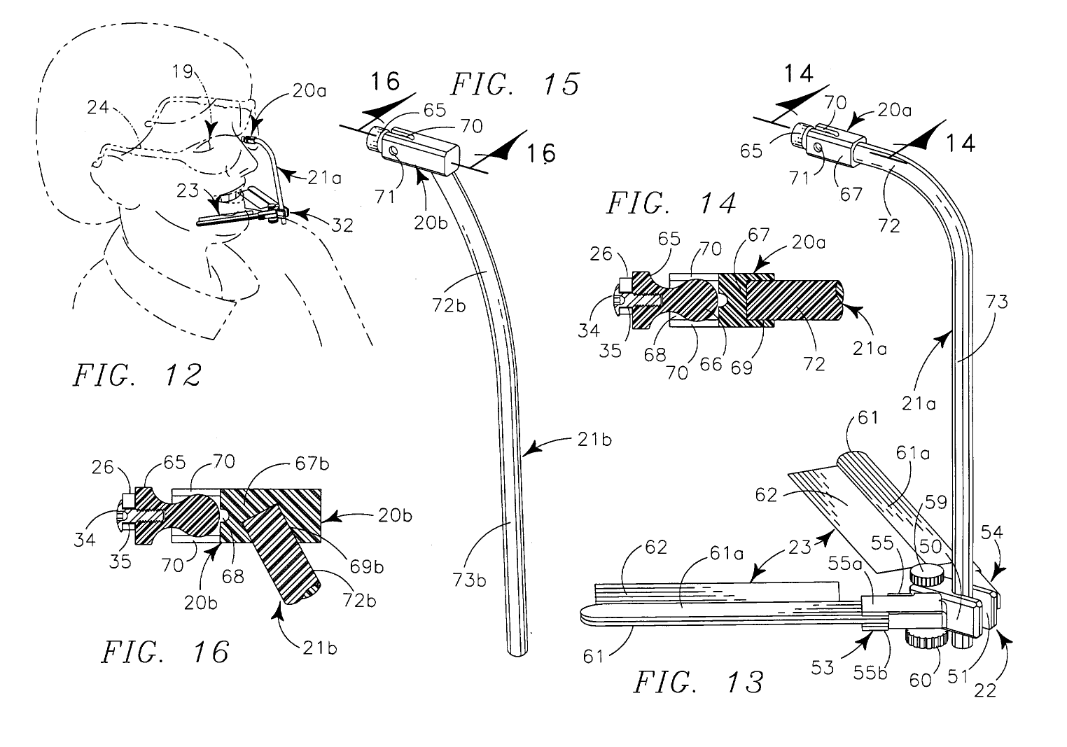

A second species of holder having a unitary holder arm 21a is shown in FIGS. 12-17. In the first sub-species of this second species, shown in FIGS. 13 and 14, glasses fastening body 20a provides a base having a rearward attachment portion 65 with a forward bulbous connecting portion 66. The base 65, 66 supports elongate fastening arm fastener 67 which defines chamber 68 in its rearward portion to receive connecting portion 66 for universal motion of the base, as shown particularly in FIG. 14. The forward portion of fastening arm fastener 67 defines hole 69 to receive and structurally carry fastening arm 21a extending horizontally forwardly from the fastening arm fastener 67. The dimensioning and configuration of connecting portion 66 of the base and chamber 68 of the fastening arm fastener should be such as to provide a frictional fit between these elements that allows manual manipulation for relative positioning but after positioning the elements will maintain positional stability by reason of frictional engagement. This function may be obtained by forming these interconnected elements from resiliently deformable material that has some retentent memory such as plastics which by reason of their physical deformability also allow assemblage of the connecting portion 66 of the body in chamber 68 of the first fastening arm fastener 67. This action is enhanced by elongate vertical slot 70 created in the rearward portion of the fastening arm fastener 67 and horizontal axially aligned holes 71 created in the sides of the fastening arm fastener as illustrated.

In the first sub-species of the second species of unitary fastening arm illustrated in FIG. 13 the fastening arm 20a is L-shaped formed by shorter upper horizontal arm 72 and a longer lower vertical arm 73, both having a uniform circular cross-section throughout their length. The L-shape of the unitary fastening arm 20a is required to positionally maintain the depending lower arm 73 spacedly forwardly of a patient's nose structure when the holder device is supported on safety glasses 19, as seen in FIG. 12. The marking film holder 22 that is supported on lower vertical arm 73 is substantially the same as that used with the first species of the holder and functions in substantially the same manner. In this first sub-species of the second species of holder device the holder arm 21a may be formed of a rigid material that need not change its shape for use, such preferably as a harder, more rigid plastic.

A second sub-species of the second species of the holder is shown in FIG. 16 where it is seen to provide somewhat the same glasses fastening body 20b as the first sub-species, except that the fastening arm fastener 67b is somewhat longer and defines downwardly and forwardly angulating hole 69b to receive and structurally maintain the upper end portion of connecting arm 21b, as seen FIGS. 15 and 16 of the drawings.

In the second sub-species of the second species of holder the unitary holding arm 21b provides no distinct upper horizontal portion but rather is formed by a forward and downwardly curving arcuate upper portion 72b which interconnects a shorter vertical portion 73b to interconnect the same marking film holder 22 of the first species of holder. This fastening arm 21b has substantially the same total vertical dependency as fastening arm 21 of the first species of holder or the fastening arm 21a of the first sub-species of the second species of holder so as to interconnect the marking film holder 22 at substantially the same vertically depending position and has a substantially uniform circular cross-sectional configuration throughout its length. Preferably the fastening arm 21b is formed of a material that has more plastic formability and less retentent memory than the material from which the fastening arm 21a is formed so that the fastening arm 21b may be manually configured and thereafter will substantially retrain a configuration once established unless and until it is manually reconfigured. Various plastics having this physical characteristic are known and available in the present day marketplace.

A third sub-species of the second species of holder is shown in FIG. 17. Here forwardly and downwardly angulated mounting arm 74 extends between nose bridge support 26 of safety glasses 19 and fastening portion 65 of glasses fastening body 20c. The cross-sectional view of FIG. 17 of this structure is as would exist if taken on the line 16-16 of FIG. 15. The rearward portion 75 of mounting arm 74 is fastened on the forward surface of nose bridge support 26 by bolt 34 extending through hole 35 defined in the nose bridge support and into threaded engagement within hole 76 defined in mounting arm 74. The lower vertical surface 77 of the mounting arm 74 carries glasses fastening body 20c which is substantially the same as the glasses fastening body 20a of the first sub-species of the second sub-species of holder. Fastening portion 65 of glasses fastening body 20c is structurally interconnected to the mounting arm 74 by bolt 78 extending through hole 79 defined in the mounting arm and into treaded engagement with fastening portion 65. The fastening portion 65 carries fastening arm fastener 67 which in turn carries vertically depending holder arm 21c which may be substantially the same as the fastening rods 21a or 21b or may be a vertically depending linear fastening rod of either rigid or manually moldable nature. The forwardly and downwardly angulated mounting arm 74 in combination with glasses fastening body 20c will maintain the holder arm 21c forwardly of the nose structure of a user.

To use my film holder in any of its species or sub-species, it firstly is attached to the nose bridge support 26 of a pair of dental patient's protective eye glasses 19 having ear bows 24 for support on the patient's ears that are interconnected in their forwardmost portions by face bow 25 having nose bridge support 26 in a medial position. The attachment is accomplished as hereinbefore specified and the holder structure is configured relative to the protective eye glasses 19 substantially as illustrated in FIGS. 1 or 12, with holder arm 21 angulating forwardly and downwardly to a position spacedly forward of the patient's nose and spacedly below the level of the patient's mouth. Marking film holder body 50 is positioned on lower portion of the holder arm 21 so it will be spacedly below a horizontal plane through the mouth of the patient and spacedly forwardly thereof with holding elements 55 extending rearwardly so that marking film structures held therein will be extendable into the patient's mouth. The protective eye glasses 19 and attached holder are then established in normal wearing position on the patient.

Marking film structures 23 may be established in the marking film holder 22 either before placement of the eye glasses carrying the holder on the patient or after such placement, as preferred by the person using the device. For placement a marking film structure 23 is grasped by the back 61 and manually moved so as to insert handle fastening portion 61b in channel 56 of a holding element 55 by inserting the handle fastening portion firstly between the upper and lower extensions 55a and subsequently into channel 56. In this condition the holder is ready for use and the marking film structures are manually moved to a position extending into the patient's open mouth and open jaw between the portions of the dental arches that are to be marked.

To accomplish marking the holder is adjusted by moving the marking film mounting arms 53, 54 to be substantially tangent to the portion or portions of the dental arches to be marked with the marking film 62 appropriately positioned to extend between the portions of the dental arches to be marked. The marking process then proceeds in traditional fashion by requesting the patient to move the dental arches together or in a chewing motion relative to each other, as may be desired, or the dental professional may move the mandibular structure manually to cause marking as desired.

The foregoing description of my invention is necessarily of a detailed nature so that a specific embodiment of it might be set forth as required, but it is to be understood that various modifications of detail, rearrangement and multiplication of parts might be resorted to without departing from its spirit, essence or scope.

Having thusly describe my invention, what I desire to protect by Letters Patent, and

What I claim is:

1. A dental marking film holder structure, supported on dental patient protective glasses having elongate lateral ear bows interconnected in their forward portions by a brow bow extending therebetween having a medial nose bridge support, comprising in combination:
a protective glasses fastening body having means for releasable attachment to the nose bridge support of the patient protective glasses and extending forwardly thereof to movably carry for adjustable positionally sustainable motion in at least a first laterally extending vertical plane forwardly of the patient's face a glasses fastening body extending spacedly forwardly from the protective glasses nose bridge;
an elongate holder arm having an upper portion carried by the glasses fastening body to depend therefrom, forwardly of the face of a patient wearing the protective glasses supporting the film holder, and a lower portion extending spacedly below the mouth of the patient;
a marking film holder carried on the lower portion of the holder arm for positionally sustainable vertical sliding motion thereon, said marking film holder carrying for positionally sustainable adjustable pivotal motion in a second horizontal plane perpendicular to the first vertical plane at least one marking film mounting patient, said marking film mounting arm having means for releasably attaching a marking film structure thereto for positional maintenance between the dental arches of the patient.

2. The dental marking film holder of claim 1 wherein the elongate holder arm is of a compound nature having an upper portion carried by the glasses fastening body and a lower portion pivotally carried by the upper portion to depend from the upper portion for motion in a third elongately extending vertical plane, substantially perpendicular to the first vertical plane, toward and away from the patient's mouth.

3. The dental marking film holder of claim 1 wherein the elongate holder arm is of a unitary nature and formed of material that is manually moveable in its various portions to a configurationally sustainable form.

4. The dental marking film holder of claim 1 wherein the protective glasses fastening body is of a compound nature having a body releasably attached to the nose bridge support of patient protective glasses and pivotably carrying a forwardly extending holding arm fastening pin which releasably carries the elongate depending holder arm.

5. The dental marking film holder of claim 1 wherein:
wherein:
the protective glasses fastening body comprises a fastening portion releasably carried by the nose bridge support of the patient protective glasses at a first rearward end and defining a ball-type connecting portion at a second end and;
the fastening arm fastener defines a chamber comprising a socket that pivotably interconnects the ball-type connecting portion of the fastening portion to allow limited universal pivotable motion in three mutually perpendicular planes of the fastening arm fastener.

6. The dental marking film holder of claim 1 wherein the marking film holder carries two marking film mounting arms for pivotal motion relative to each other and to the marking film holder, each marking film mounting arm having means for releasably attaching a marking film structure therein in a substantially co-planer relationship.

7. The dental marking film holder of claim 1 releasably carrying a marking film structure in the at least one marking film mounting arm, said marking film structure having a flexible but configurationally sustainable elongate back with a handle fastening portion at a first end for releasable attachment within the holding element of the marking film holder and a film holding portion at a second end carrying a strip of non-rigid dental marking film extending laterally therefrom to mark contact points of at least one dental arch of the patient responsive to pressure between the marking film and the dental arch to be marked.

8. The dental marking film holder of claim 1 wherein the protective glasses fastening body further includes:
an elongate mounting arm having a rearward portion releasably fastenable to the nose bridge support of the protective glasses and a forward portion extending spacedly downwardly and forwardly to releasably carry the glasses fastening body.

9. A dental marking film holding apparatus comprising in combination:
patient protective glasses having two spacedly adjacent elongately extending ear bows, with rearward and forward ends, interconnected by a brow bow extending between the forward end portions of the ear bows and carrying a medial nose bridge support and similar depending safety lens between the forward end portion of each ear bow and the nose bridge support; and
dental marking film holder structure supported on the nose bridge support to depend therefrom, said marking film holder structure having
a protective glasses fastening body releasably supported on the nose bridge extending spacedly forwardly thereof, said glasses fastening body having means for releasable attachment of a holder arm thereto,
an elongate holder arm having an upper portion and a lower portion, said holder arm carried in its upper portion by the glasses fastening body to depend therefrom spacedly forward of the face of a patient using the marking film holding apparatus and spacedly below the mouth of the patient, and
a marking film holder carried on the lower portion of the holder arm for positionally sustaining frictionally restrained sliding motion thereon, said marking film holder pivotably carrying at least one marking film mounting arm for adjustable frictionally restrained pivotal motion in a first horizontal plane, each at least one marking film mounting arm having a holding element in its rearward portion defining a channel to receive and frictionally positionally maintain a marking film structure extending rearwardly from the marking film holder for placement between the dental arches of the patient.

10. The dental marking film holding apparatus of claim 9 wherein:
the glasses fastening body comprises a body portion movably carrying a holding arm fastening for frictionally adjustable rotary motion in a laterally extending vertical plane, extending forwardly of the body portion to releasably carry the holder arm, and
the holder arm is a compound structure with the upper portion pivotally carrying the lower portion for frictionally adjustable positionally sustaining motion in an elongately extending vertical plane toward and away from the mouth of the patient.

11. The dental marking film holding apparatus of claim 9 further characterized by:
the fastening body having a rearward fastening portion releasably attached to the nose bridge of the protective glasses with a ball-like connecting portion extending forwardly therefrom and a fastening arm fastener defining a rearward socket-like chamber to movably receive the ball-like connecting portion of the fastening portion for frictionally restrained pivotal motion in three mutually perpendicular planes and
the holder arm comprises a unitary elongate rod, of substantially similar cross-sectional configuration throughout its length, depending spacedly forwardly of the patient's face and spacedly below the patient's mouth.

12. The dental marking film holding apparatus of claim 11 further characterized by the holder arm being formed of plastic material that allows manual reconfiguration and is configurationally sustaining after manual reconfiguration.

13. The dental marking film holding apparatus of claim 9 further characterized by:
the dental marking film holder having two substantially co-planer marking film mounting arms pivotally movable relatively to each other and to the dental marking film holder and
at least one marking film mounting arm releasably carrying a marking film structure having an elongate rigid back with a handle fastening portion at a first end for releasable attachment within the holding element of the marking film holder and a film holding portion at a second end carrying a strip of dental marking film extending laterally therefrom to contact at least one dental arch of the patient for marking responsive to pressure between the marking film and the dental arch to be marked.

14. The dental marking film holding apparatus of claim 11 wherein the glasses fastening body is carried by a mounting arm releasably supported by a nose bridge support of the patient protective glasses to extend spacedly forwardly and downwardly from the nose bridge to releasably interconnect the rearward fastening portion of the glasses fastening body.
